(19) United States
(12) Patent Application Publication
(10) Pub. No.: US 2008/0238080 A1
(43) Pub. Date: Oct. 2, 2008

(54) Medication Tracking Diary

(76) Inventor: Ross Brodie, Venice, CA (US)

Correspondence Address: ALTIMATIA, L.L.C., 16 ELM RIDGE ROAD, PENNINGTON, NJ, 08534, US

(21) Appl. No.: 11/691,407

(22) Filed: Mar. 26, 2007

(51) Int. Cl. B42D 1/00

(52) U.S. Cl. 281/15.1

(57) ABSTRACT

Embodiments of the invention comprise a medication tracking diary for use in tracking medications consumed by a subject as well as for use in reminding a subject to consume medications on schedule. Embodiments of the invention may also serve as a convenient, portable, medical history, allowing health care professionals quick access to the information regarding a subject's health. Embodiments of the invention comprise a medication tracking diary further comprising front and back covers, medication description sheets, and medication consumption sheets. A user of an embodiment of the invention may record medication description information, as well as information related to medication consumption.

### CROSS REFERENCE TO RELATED APPLICATIONS

1. Field

Embodiments of the invention relate to medication consumption tracking and health monitoring.

2. Background

As people age they are often required to take medication to maintain health. Medications such as blood pressure medication, diabetes medication, pain medication, vitamins, and aspirin are examples of medications that people often take on a regular basis. Remembering to take medication and remembering whether medication has been taken is a problem. When a subject must take multiple medications the problem is compounded.

When subjects are taking multiple medications, they are often being treated by multiple providers. If each provider is not aware of the medications being taken by a subject, they may prescribe medications that interact badly with the other medications the subject is taking. Thus there is a need to provide medical professionals with up-to-date information about the medications currently taken by a subject.

For optimal effect, particular medications should be consumed at particular times of day such as upon waking, before or after a meal, during the evening, or just before going to bed. Relying on memory to determine when to take medication leads to mistakes that reduce the effectiveness of the medication and can also cause unpleasant side effects. For example, a medication that should be consumed with a meal may cause nausea if taken on an empty stomach. Likewise, if a subject takes a medication upon waking that should have been taken before sleeping, the subject may spend the day fighting a medication side effect such as drowsiness.

When a subject is given a new medication it is often useful to maintain a record of side effects and symptoms. Such a record may be examined by physicians, nurses, pharmacists, and other health professionals to monitor treatment progress and determine future actions.

Various attempts to address these problems have been offered. For example, U.S. Pat. No. 3,099,352 discloses a calendar and dispenser device. The device contemplates a combination of a base or support member, having indicated thereon by printing, or otherwise, a series of adjoining serially numbered spaces, such as a weekly or monthly calendar, to which containers holding the pills or capsules are attached so as to cover the spaces. Preferably the containers are individual pockets, or in strip form having weakened zones which permit tearing away one dose at a time.

U.S. Pat. No. 4,905,388 discloses an organizer and reminder device for pills, medicines, and the like. The organizer and reminder device is generally presented in a calendar format to remind the user to take certain pills medicines, etc. on indicated days of the month. It provides a plurality of containers secured on a mounting panel through windows representative of days of the month and formed in a plurality of stacked sheets. Each sheet is representative of a different month of the calendar year and an exposed one of the stacked sheets is representative of a current month. One or more pills, medicines, etc. to be taken on a given day of the month are located in an appropriately positioned container.

Also known are pill holders that contain seven or more individual containers into which a week's worth of pills may be placed. The container lids may be labeled with the days of the week and by filling the containers at the beginning of the week and taking each container's medications on the indicated day, a week's worth of medications may be appropriately taken.

Printable, downloadable medication calendars are available, but are often not accessible to older subjects, who may lack access to the internet. Such systems also may require daily rerecording of medication information.

U.S. Patent Application Publication 2004/01448824 offers another solution. The device is a personal medical calendar that has a plurality of sheets where each sheet has calendar indicia on one side and an informational form disposed on the opposite side for recording various medical related information, a front cover having an inside surface with a medical form disposed thereon for recording personal medical history information particular to a user, and a back cover. The plurality of sheets, the front cover and the back cover are connected to each other with a joining structure along one edge.

Hospitals have advanced medication tracking and charting systems. However, such systems are typically too complex for personal or home use. Medical personnel often require training and instruction in order to properly and accurately medication consumption.

What is needed is a medication tracking system or diary that both reminds a user when to take medication as well as allows a user to record the fact that medication has been taken. Such a system would allow a user to record pertinent information related to medications such as size, shape, color, frequency of consumption, and other information. The system would also allow a user to record the date, day of the week, and time of day when medication was taken, and also allow a user to record any symptoms or side effects experienced. The system would be a convenient size to allow a user to carry the system with them during their daily travels. In addition, the system would minimize the amount of redundant writing required of the user. Static information related to medications could be recorded once and then be used multiple times for multiple individual days. In addition to tracking medications such a system could also be used to track meals, calorie consumption, exercise, and other health related information.

### SUMMARY

Embodiments of the invention comprise a system which allows medication tracking with minimal rewriting. One part of the system is a medication description sheet on which a list of medications taken by a subject may be recorded. The medication list optionally comprises a listing of medication properties such as color, size, shape, frequency of use, indication for use, prescribing medical practitioner, and instructions for use. Another part of the system is a medication consumption sheet on which medications consumed by a subject may be recorded.

A medication description sheet is typically part of a pad of sheets. This allows for the replacement of a sheet when a medication is altered. Old sheets may be kept to create a medication journal, or the sheets may be discarded. A medication description sheet is typically divided, by horizontal lines, into a plurality of boxes. Each box provides at least one location for recording information related to a medication.

A medication consumption sheet is typically part of a pad of sheets. This allows for daily tracking and visualization of medication consumption. A sheet may be saved by folding it over, creating a medication consumption journal, or a sheet may be discarded at the end of a day. A fresh sheet underneath is then ready for use. A medication consumption sheet is divided by horizontal lines into a plurality of medication-type rows. The number of medication-type rows on a medication consumption sheet equal the number of boxes on a medication description sheet. In addition, the medication-type rows on a medication consumption sheet are horizontally aligned with the medication description boxes on a medication description sheet (FIG. 3). When a medication consumption sheet is folded over, or removed, the rows of the freshly exposed medication consumption sheet are still aligned with the medication description boxes of the adjcent medication description sheet, eliminating the need to reenter medication description data. Elimination of tedious data reentry simplifies the use of the system, removes a source of errors, and enhances user acceptance of the system.

Embodiments of the invention are portable, self-contained medication tracking diaries comprising front and back covers, medication description pads, and medication consumption pads. The medication description and medication consumption pads comprise individual medication descripton and medication consumption sheets. Diaries of the invention may be used as portable medical histories, allowing the communication of subject information to multiple health professionals. Each professional may examine a diary of the invention and be informed of all the medications which a subject is currently taking, medical conditions for which a subject is being treated, and other relevant information related to the subject.

### BRIEF DESCRIPTION OF THE DRAWINGS

FIG. 1 shows a front cover of an embodiment of the invention.

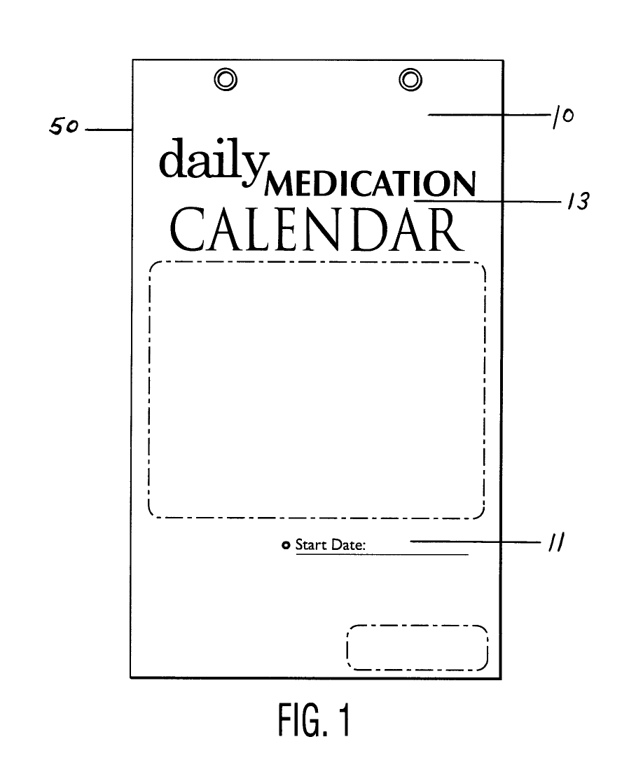

FIG. 2 shows a back cover of an embodiment of the invention.

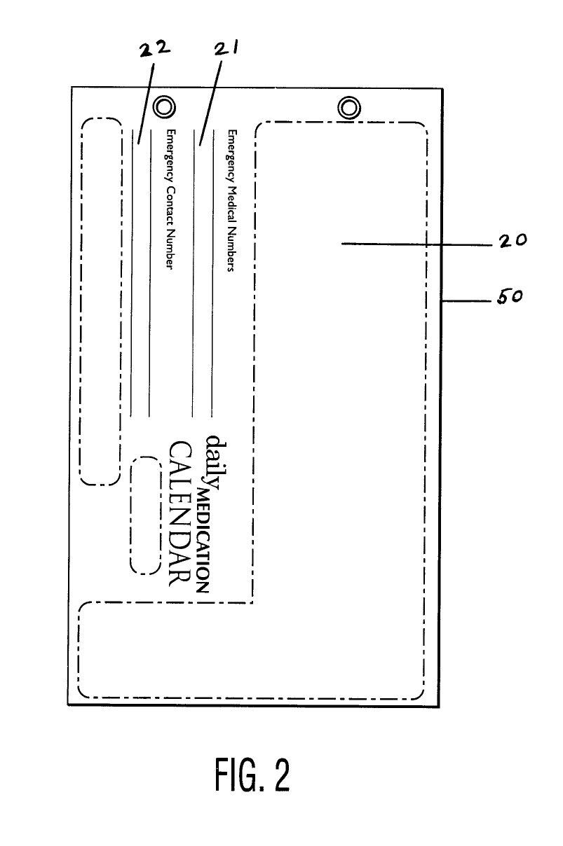

FIG. 3 shows the inside, displaying the medication description and medication consumption pads, of an embodiment of the invention.

### DETAILED DESCRIPTION

As used herein a “subject” is a person or animal in need of, or undergoing treatment. Subjects may include persons, dogs, cats, horses, sheep, pigs, cows, bulls, frogs, rabbits, lizards, snakes, insects, or any other living thing.

As used herein “medication” refers to prescription medication, nonprescription medication, vitamins, supplements, herbs, foods, bandages, wraps, first aid devices, subject cleaning solutions, exercise, physical therapy, and the like.

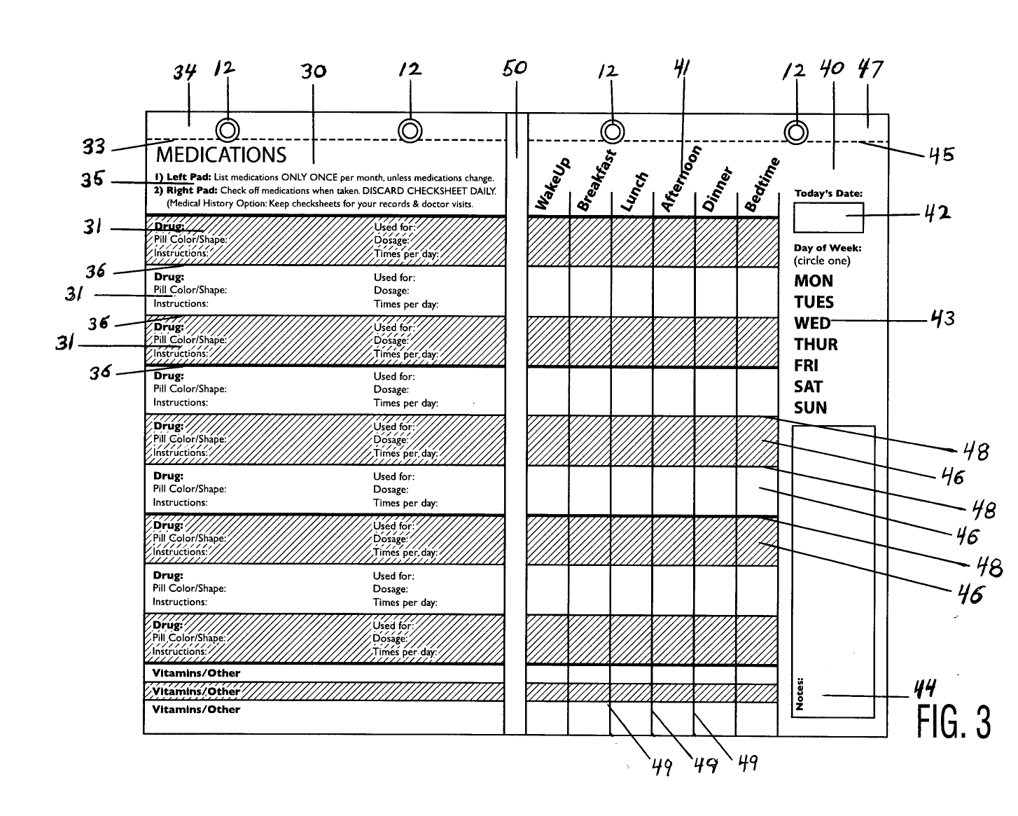

As used herein “record” and “recording” are defined as making a notation of information. Information may be recorded in pencil or ink through the use of a lead pencil, ink pen, fountain pen, felt tip pen, gel pen or any other convenient writing implement. In addition a record or recording may be made through the use of adhesive labels, such as address labels, or star shaped labels, heart shaped labels, cross shaped labels, dot shaped labels, or labels of any other convenient shape. In addition a record may be made through the use of an ink stamp, such as a stamp containing address information, date information, or a stamp producing a shape like a cross, a star, a dot, or other convenient shape. Any device capable of making a mark may be used to record information in embodiments of the invention. In addition, information may be recorded by marking, or circling, one of a plurality of items. For example, as shown in FIG. 3, days of the week are listed on a medication consumption sheet, and a day of the week may be recorded by circling, crossing out, drawing a line through, or otherwise marking one of the plurality of days listed on the sheet.

As used herein “consumed”, “consuming”, and “consumption” mean the taking of medication, or the performance of a health related task. Medication may be consumed orally, nasally, intravenously, rectally, through cutaneous absorption, through inhalation, or via any other method of ingesting medication. In addition, consuming may refer to performing a task, such as exercise, therapy, or washing, such as wound washing, that a subject performs on a regular basis.

As used herein a “medication tracking diary” refers to embodiments of the invention described below.

As used herein a “perforation” refers to a series of holes, in a line, across a sheet, such as a medication description sheet, or a medication consumption sheet. A perforation allows a sheet to be easily removed from a pad.

As used herein “attach” refers to connecting one item to another. Medication description and medication consumption pads may be attached to the front and back covers in a variety of ways. For example, a pad may be attached via the use of staples, rivets, grommets, bolts, ring binders, spiral binders, plastic binders, and other binders. In addition, a pad may be attached by positioning the back of a pad in a pocket located on an inside of a cover. Alternatively, a pad may be attached by placing a pad inside a pocket, where the pocket is located on the inside of the front or back cover, and where the pocket is transparent, that is having a transparent cover, thereby allowing the user to easily read the pad through the transparent pocket.

As used herein “pad” refers to a plurality of sheets, such as medication description sheets, or medication consumption sheets. The sheets in a pad are aligned with each other, and optionally held together at the top of each sheet. The sheets may be held together with glue, staples, ring bindings, spiral bindings, or other bindings such as are commonly used for legal pads, notepads, or PostIt® pads. A pad may optionally comprise a back, such as a cardboard back, or other back.

A first embodiment of the invention comprises a medication tracking diary comprising a front cover (10), a back cover (20), a spine (50), a medication description pad (30), and a medication consumption pad (40). The front cover is further comprised of an inside, an outside, and a left edge. A description (13) is located on the outside and a location (11), on the outside, for recording a date is also present. The left edge of the front cover is attached to the spine.

The spine (50) attaches the front cover to the back cover. The spine may comprise a spiral ring which passes through corresponding perforations in the front and back covers. Alternatively the spine may comprise a plastic member comprising a plurality of curved extensions which pass through corresponding perforations in the front and back covers. The spine may comprise other binding or attaching means such as staples, glue, ring binders, brads, or other binding means. In another alternative the front and back covers may form a single contiguous member with a fold at the location of the spine.

The back cover (20) is further comprised of an inside, an outside, and a right edge. The back cover comprises a first location (21), on the outside, for recording medical contact information. In addition, a second location (22), also on the outside back cover, for recording personal contact information is provided. The right edge of the back cover is attached to the spine (50).

The medication description pad (30) further comprises a top portion (34), where the top portion is (34) attached (12 showing grommet fastener) to the inside front cover. The medication description pad comprises at least one medication description sheet. A medication description sheet comprises medication diary instructions(35). The instructions direct medication diary users in the optimal use of the medication diary. In a preferred embodiment, a medication consumption sheet further comprises at least eleven horizontal lines (36), where the horizontal lines divide the sheet into adjacent medication description boxes (31). A shown in FIG. 3, every third horizontal line may be thicker or heavier. A medication description box comprises at least one location for recording medication information. Medication information may comprise one or more of: medication name, medication color, medication shape, medication indication, medication dosage amount, medication frequency, prescribing medical professional, and medication instructions. A medication description box comprises a background, where adjacent medication description boxes have different backgrounds. A background may comprise a pattern, a color, or a colored pattern. A medication description sheet may optionally comprise a perforation (33), where the perforation is located about 0.5 inch from, and parallel to, the top edge of the sheet. A

medication consumption pad (40) further comprises a top portion (47) attached (12) to the inside back cover. A medication consumption pad further comprises at least seven medication consumption sheets. In a preferred embodiment, a medication consumption sheet further comprises at least eleven horizontal lines (48), where the horizontal lines divide a sheet into medication-type rows (46). As shown in FIG. 3, every third horizontal line may be thicker or heavier. A medication-type row further comprises a background. Adjacent medication-type rows have different backgrounds. A background may comprise a pattern, a color, or a colored pattern. As shown in FIG. 3, each medication-type row is horizontally aligned with a corresponding medication description box of a medication description sheet, and each medication-type row has the same background as a medication description box with which it is aligned. The horizontal alignment and background continuity provide a visual aid to a user of a diary of the invention. In a preferred embodiment, a medication consumption sheet further comprises at least five vertical lines (49), where the vertical lines divide a medication consumption sheet into time-of-day columns; the columns further comprise time-of-day headings (41). Time-of-day headings may comprise general times of day such as morning, afternoon, and evening, or time-of-day headings may comprise time headings corresponding to specific hours of the day such as 9:00 a.m, 11:00 a.m., 12:00 noon, or 3:00 p.m. In another embodiment, a medication consumption sheet comprises at least eleven vertical lines. A medication consumption sheet comprises a grid pattern formed by the intersection of medication-type rows and time-of-day columns. By recording in a particular grid rectangle, a user indicates that a given medication was taken at a given time. A medication consumption sheet further comprises a location for recording a date (42), a location for recording a day of the week (43), and a location for recording notes (44). A medication consumption sheet may optionally comprise a perforation (45), where the perforation located about 0.5 inch from, and parallel to, the top edge.

A second embodiment of the invention comprises a medication tracking diary comprised of a front cover, a back cover, a spine, a medication description pad, and a medication consumption pad. The front cover further comprises an inside, an outside, and a left edge. A location, on the outside front cover, for recording a date is provided, and the left edge is attached to the spine.

The back cover further comprises an inside, an outside, and a right edge, where the right edge attached to the spine.

A medication description pad is attached the inside front cover. A medication description pad comprises at least one medication description sheet. In a preferred embodiment, a medication description sheet further comprises at least five horizontal lines, where the horizontal lines divide a sheet into adjacent medication description boxes. Optionally, every third horizontal line is thicker or heavier. A medication description box comprises at least one location for recording medication information.

A medication consumption pad is attached to the inside back cover. A medication consumption pad comprises at least seven medication consumption sheets. In a preferred embodiment, a medication consumption sheet comprises at least five horizontal lines, where the horizontal lines divide a sheet into medication-type rows. Optionally, every third horizontal line is thicker or heavier. A medication-type row of a medication consumption sheet is horizontally aligned with a medication description box of a medication description sheet. In a preferred embodiment, a medication consumption sheet further comprises at least five vertical lines, where the vertical lines divide a sheet into time-of-day columns. Time-of-day columns comprise time-of-day headings. Time-of-day headings may comprise general times of day such as morning, afternoon, and evening, or time-of-day headings may comprise time headings corresponding to specific hours of the day such as 9:00 a.m, 11:00 a.m., 12:00 noon, or 3:00 p.m. In an alternative embodiment, a medication consumption sheet comprises at least eleven vertical lines. The medication-type rows and time-of-day columns form a grid pattern. A medication consumption sheet further comprises a location for recording a date, a location for recording a day of the week, and a location for recording notes.

An embodiment of the invention may optionally comprise a description located on the outside front cover. In addition, an embodiment may optionally comprise a first location on the outside back cover, for recording medical contact information, and a second location, on the outside back cover, for recording personal contact information.

A medication description box may optionally comprise a background, where adjacent medication description boxes have different backgrounds. A background may comprise a pattern, a color, or a colored pattern.

A medication-type row of a medication consumption sheet may optionally comprise a background, where adjacent medication-type rows have different backgrounds, where each medication-type row is horizontally aligned with a corresponding medication description box of a medication description sheet, and where a medication-type row has the same background as a medication description box with which it is aligned. A background may comprise a color, a patterned, or a colored pattern.

A medication diary of the invention may optionally be rectangular with a width between about three inches to about nine inches and a length between about five inches to about fourteen inches.

A medication diary of the invention may optionally comprise a minimum of seven and a maximum of three hundred and seventy medication consumption sheets. In a preferred embodiment the number of medication consumption sheets is thirty five sheets.

A medication diary of the invention may optionally comprise a minimum of one and a maximum of fifty-two medication description sheets. In a preferred embodiment the number of medication description sheets is four sheets.

A medication diary of the invention may optionally comprise a medication description pad comprising a top portion and a medication consumption pad comprising a top portion. The top portion of a medication description pad may optionally be attached to the inside front cover and the top portion of a medication consumption pad may optionally be attached to the inside back cover. The pads may be attached by means of staples, glue, ring bindings, spiral bindings, brads, grommets, or other binding means.

A medication diary of the invention may optionally comprise perforated medication description sheets, where the perforation is located about 0.5 inches from the top edge of a sheet. A medication diary of the invention may optionally comprise perforated medication consumption sheets, where the perforation is located about 0.5 inches from the top edge of a sheet.

A medication diary of the invention may optionally comprise glued medication description sheets and glued medication consumption sheets, where a weak glue bonds the sheets together, such as in PostIt® type note pads. A medication diary of the invention may optionally comprise glued medication description sheets and glued medication consumption sheets, where a glue or adhesive layer binds the top edges of the sheets together, such as commonly found in notepads, legal pads, and the like. Medication description pads and medication consumption pads may further comprise a back, such as a cardboard back, as is commonly found in notepads, legal pads, and the like.

A medication diary of the invention may optionally comprise a first pocket located on the inside front cover, and a second pocket located on the inside back cover. A medication description pad may optionally comprise a back, and a medication consumption pad may optionally comprise a back. A pad back may be made of cardboard, such as the backs of legal pads, or note pads. A pad back may also be comprised of other suitable materials. A medication description pad, comprising a back, may be attached to a front cover by positioning the back in a first pocket, thereby attaching the pad to the cover. In addition, a medication consumption pad, comprising a back, may be attached to a back cover by positioning the pad back in a second pocket, thereby attaching the pad to the cover.

A medication diary of the invention may optionally comprise a first transparent pocket located on the inside front cover, and may also optionally comprise a second transparent pocket located on the inside back cover. A transparent pocket is a pocket with a transparent cover. The transparent cover allows the user of the diary to read the contents of items placed within the pocket, items such as medication description sheets and medication consumption sheets. A medication description pad may be attached to a diary of the invention by placing the pad into a first pocket located on the inside front cover. Any medication description information recorded thereon will be visible and legible through the transparent cover. A medication consumption pad may be attached to a diary of the invention by placing the pad into a second pocket located on the inside back cover. Medication consumption information recorded thereon will be visible and legible through the transparent cover.

Another embodiment of the invention provides a method of using a medication tracking diary of the invention. The method comprises the steps of recording a start date on the outside front cover, recording medication information in at least one location of at least one medication description sheet. Information related to a single medication is recorded within a single location. The method further comprises the step of recording a date in a date recording location of a medication consumption sheet and recording a day of the week in a day of the week location of a medication consumption sheet. The method further comprises the step of recording medication consumed in a grid box formed by the intersection of a medication-type row with a time-of-day column.

The method may optionally comprise the step of recording any notes in a notes location of a medication consumption sheet.

The method may optionally comprise the step of recording medical contact information in a first location provided on the outside back cover. The method may also optionally comprise the step of recording personal contact information in a second location provided on the outside back cover.

Although preferred embodiments of the present invention have been described herein, the above description is merely illustrative. Further modification of the invention herein disclosed will occur to those skilled in the respective arts and all such modifications are deemed to be within the scope of the invention as defined by the appended claims.

I claim:

1. A medication tracking diary comprising a front cover, a back cover, a spine, a medication description pad, and a medication consumption pad;
the front cover further comprising:
an inside, an outside, and a left edge;
a description located on the outside;
a location, on the outside, for recording a date;
the left edge attached to the spine;
the back cover further comprising:
an inside, an outside, and a right edge;
a first location, on the outside, for recording medical contact information;
a second location, on the outside, for recording personal contact information;
the right edge attached to the spine;
the medication description pad comprising:
a top portion;
the top portion attached to the inside front cover;
at least one medication description sheet;
where a medication description sheet comprises:
a top edge;
a perforation located about 0.5 inch from, and parallel to, the top edge;
medication diary instructions;
at least eleven horizontal lines;
the horizontal lines dividing a medication description sheet into adjacent medication description boxes;
the medication description boxes comprising at least one location for recording medication information;
the medication information comprising one or more of:
medication name, color, shape, indication, dosage amount, frequency, and instructions;
the medication description boxes comprising backgrounds;
where adjacent medication description boxes have different backgrounds;
the medication consumption pad further comprising:
a top portion;
the top portion attached to the inside back cover;
at least seven medication consumption sheets;
where a medication consumption sheet comprises:
a top edge;
a perforation located about 0.5 inch from, and parallel to, the top edge;
a location for recording a date;
a location for recording a day of the week;
a location for recording notes
at least eleven horizontal lines;
where the horizontal lines divide a medication consumption sheet into medication-type rows;
where a medication-type row comprises a background;
where adjacent medication-type rows have different backgrounds;
where a medication-type row is horizontally aligned with a corresponding medication description box of a medication description sheet;
where a medication-type row has the same background as a medication description box with which it is aligned;
at least five vertical lines;
where the vertical lines divide a medication consumption sheet into time-of-day columns;
where a time-of-day column comprises a time-of-day heading;
where medication-type rows and time-of-day columns form a grid pattern.

2. A medication tracking diary comprising a front cover, a back cover, a spine, a medication description pad, and a medication consumption pad;
the front cover further comprising:
an inside, an outside, and a left edge;
a location, on the outside, for recording a date;
the left edge attached to the spine;
the back cover further comprising:
an inside, an outside, and a right edge;
the right edge attached to the spine;
the medication description pad, attached to the inside front cover, further comprising:
at least one medication description sheet;
where a medication description sheet comprises:
at least five horizontal lines;
where the horizontal lines divide a medication description sheet into medication description boxes;
where the medication description boxes comprise at least one location for recording medication information;
the medication consumption pad, attached to the inside back cover, further comprising:
at least seven medication consumption sheets;
where a medication consumption sheet comprises:
at least five horizontal lines;
where the horizontal lines divide a medication consumption sheet into medication-type rows;
where each medication-type row is horizontally aligned with a corresponding medication description box of a medication description sheet;
at least five vertical lines;
where the vertical lines divide a medication consumption sheet into time-of-day columns;
where a time-of-day column comprises a time-of-day heading;
where the medication-type rows and time-of-day columns form a grid pattern;
a location for recording a date;
a location for recording a day of the week;
and a location for recording notes.

3. The medication tracking diary of claim 2 further comprising a description located on the outside front cover.

4. The medication tracking diary of claim 2 further comprising:
a first location, on the outside back cover, for recording medical contact information;
and a second location, on the outside back cover, for recording personal contact information.

5. The medication diary of claim 2 wherein,
a medication description box further comprises a background;
and where adjacent medication description boxes comprise different backgrounds.

6. The medication diary of claim 5 wherein,
a medication-type row further comprises a background;
where adjacent medication-type rows comprise different backgrounds;
where a medication-type row is aligned with a medication description box;
and where a medication-type row has the same background as a medication description box with which it is aligned.

7. The medication diary of claim 5 wherein the backgrounds comprise colored backgrounds, patterned backgrounds, and colored patterned backgrounds.

8. The medication diary of claim 2 wherein the diary is rectangular comprising a width between a minimum of about 3 inches to a maximum of about 9 inches and a length between a minimum of about 5 inches to a maximum of about 14 inches.

9. The medication diary of claim 2 wherein the number of medication consumption sheets is between a minimum of seven and a maximum of three hundred and seventy.

10. The medication diary of claim 2 wherein the number of medication consumption sheets is thirty five sheets.

12. The medication diary of claim 2 wherein the number of medication description sheets is between a minimum of one and a maximum of fifty-two sheets.

13. The medication diary of claim 2 wherein:
the medication description pad further comprises a top portion;
the medication consumption pad further comprises a top portion;
where the medication description pad top portion is attached to the inside front cover;
where the medication consumption pad top portion is attached to the inside back cover
where a medication description sheet further comprises a first top edge and a perforation located about 0.5 inch from, and parallel to, the first top edge;
where a medication consumption sheet further comprises a second top edge and a perforation located about 0.5 inch from, and parallel to, the second top edge.

14. The medication diary of claim 2 wherein:
the inside front cover comprises a first pocket;
the inside back cover comprises a second pocket;
the medication description pad comprises a back;
the medication consumption pad comprises a back;
where the back of the medication description pad is positioned in the first pocket;
and where the back of the medication consumption pad is positioned in the second pocket.

15. The medication diary of claim 2 wherein
the inside front cover comprises a first pocket further comprising a transparent cover;
and the medication description pad is placed within the first pocket such that a medication description sheet is legible through the transparent cover.

16. The medication diary of claim 15 wherein
the inside back cover comprises a second pocket comprising a transparent cover;
a medication consumption pad is placed within the second pocket such that a medication consumption sheet is legible through the transparent cover.

17. A method of using a medication tracking diary
the medication tracking diary comprising a front cover, a back cover, a spine, a medication description pad, and a medication consumption pad;
the front cover further comprising:
an inside, an outside, and a left edge;
a description located on the outside;
a location, on the outside, for recording a date;
the left edge attached to the spine;
the back cover further comprising:
an inside, an outside, and a right edge;
a first location, on the outside, for recording medical contact information;
a second location, on the outside, for recording personal contact information;
the right edge attached to the spine;
the medication description pad comprising:
the medication description pad attached to the inside front cover;
at least one medication description sheet;
where a medication description sheet comprises:
medication diary instructions;
at least five horizontal lines;
the horizontal lines dividing a medication description sheet into adjacent medication description boxes;
the medication description boxes comprising at least one location for recording medication information;
the medication information comprising one or more of:
medication name, color, shape, indication, dosage amount, frequency, and instructions;
the medication consumption pad further comprising:
the medication consumption pad attached to the inside back cover;
at least seven medication consumption sheets;
where a medication consumption sheet comprises:
a location for recording a date;
a location for recording a day of the week;
a location for recording notes
at least five horizontal lines;
where the horizontal lines divide a medication consumption sheet into medication-type rows;
where a medication-type row is horizontally aligned with a corresponding medication description box of a medication description sheet;
at least five vertical lines;
where the vertical lines divide a medication consumption sheet into time-of-day columns;
where a time-of-day column comprises a time-of-day heading;
where medication-type rows and time-of-day columns form a grid pattern; the method comprising the steps of:
recording a starting date on the outside front cover;
recording medication information in at least one location of at least one medication description sheet;
where information related to a single medication is recorded within a single location; recording a date in a date recording location of a medication consumption sheet;
recording a day of the week in a day of the week recording location of a medication consumption sheet;
recording medication consumption in a grid box formed by the intersection of a medication-type row with a time-of-day column.

18. The method of step 17 further comprising the step of recording notes in a notes location of a medication consumption sheet.

19. The method of step 17 further comprising the step of recording medical contact information on the outside back cover.

20. The method of step 19 further comprising the step of recording personal contact information on the outside back cover.
